(19) United States
(12) Patent Application Publication
(10) Pub. No.: US 2011/0126022 A1
(43) Pub. Date: May 26, 2011

(54) METHOD FOR GENERATING AN ADVANCED ELECTRONIC SIGNATURE FOR AN ELECTRONIC DOCUMENT

(76) Inventor: Walter Sieberer, Leonding (AT)

(21) Appl. No.: 11/817,491

(22) PCT Filed: Nov. 8, 2006
(86) PCT No.: PCT/AT2006/000453

§ 371 Date: May 12, 2008

(30) Foreign Application Priority Data
Nov. 9, 2005 (AT) A 1831/2005

(51) Int. Cl. H04L 9/32

(52) U.S. Cl. 713/180

(57) ABSTRACT

A process for the generation of an advanced electronic signature of an electronic document (4) using a signature creation unit (1) comprises the generation of unambiguous user identification data (BI) of a signer; the generation of a one-time used session key (SK); the encryption (BI_crypt) of the user identification data (BI) with the session key (SK); the asymmetric encryption (SK_crypt) of the session key (SK) with a public key (OSK) of a signature server (2); the linking of the electronic document (4), of the encrypted (BI_crypt) user identification data (BI) and of the encrypted (SK_crypt) session key (SK) into a data stream and the formation of an original hash value (OH) from the data stream using a hash algorithm; the generation of a one time certificate key pair (PCZ, OCZ); the generation of a digital client signature (DCS) by encrypting the original hash value (OH) with the private key (PCZ) of the one time certificate key pair; the generation of a digital seal (6, 6′) containing the encrypted (BI_crypt) user identification data (BI), the encrypted (SK_crypt) session key (SK), the digital client signature (DCS) and the public key (OCZ); the embedding of the digital seal (6, 6′) in the electronic document (4).

### BACKGROUND OF THE INVENTION

1. Field of the Invention

The invention relates to a process for the advanced electronic signing of an electronic document according to the preamble of claim 1.

Furthermore, the invention relates to a process for examining an electronic document, which has been signed electronically according to the above-indicated process, according to the preamble of claim 11.

2. Description of the Related Art

In order to facilitate electronic communication and electronic business transactions, the European Parliament and the EU Council issued a guideline (RL 1999/93/EG) on common general conditions for electronic signatures on Dec. 13, 1999.

Data in electronic form, which is added to other electronic data, is logically linked thereto and serves for authentication, is defined as an “electronic signature”.

Moreover, an “advanced electronic signature” is defined as a signature which is allocated exclusively to the signer, enables the identification of the signer, is established by means which the signer can keep under his or her sole control and which thus is linked to the data it refers to so that a subsequent modification of said data can be detected.

The “signer” or “signator”, respectively, is a person who possesses a “signature creation unit”, i.e., a configured software or hardware which is used for the implementation of signature creation data. The “signature creation data” is comprised of unique data such as codes or private cryptographic keys which are used by the signer for creating an electronic signature.

By means of “signature test data” comprising data such as codes or public cryptographic keys, an examination of an electronic signature can be performed and a “certificate” can be issued, i.e., an electronic certification via which signature test data is allocated to a person and the identity of said person is verified.

In the context of the cited EU guideline 1999/93/EG, the present invention belongs to the field of an “advanced electronic signature”.

### SUMMARY OF THE INVENTION

For the previously known solutions for creating an advanced electronic signature, each signer requires a separate certificate/pair of keys (stored, e.g., in a SmartCard) handed over to him or her in the course of registering with a certification service provider. For example, in public key infrastructures based on X.509, such a certificate is usually issued at the beginning of the business connection between the signator and the certification service provider and subsequently is used by the signator without any interaction with the certification service provider.

The present invention differs from these known implementations by a technical solution for an advanced electronic signature based on individual certificates or key pairs, respectively. Unlike in said known solutions, according to the invention, the individual certificates are not “issued” personally but are, in each case, created as “one time certificates” only during the runtime of the signing operation in the signature creation unit. Nevertheless, via the superimposed application level of the signature creation unit, they are allocated to the respective signator and are under his or her sole control!

The advantage of said solution according to the invention is that no individual certificates designed as a “public key infrastructure” have to be managed. In addition, by means of the invention, it has become possible for the first time to perform the creation of the advanced electronic signature only in knowledge of a self-defined authentication code, which protects the “user account” and, respectively, the signer's authorization to use the signature service.

The process, according to the invention for an advanced electronic signing of an electronic document using a signature creation unit, is characterized by the features indicated in claim 1. The process, according to the invention for examining an electronic document signed electronically according to the above-indicated process, is defined by the process steps of claim 11. Advantageous embodiments of the invention are set forth in the sub-claims.

Further features and advantages of the invention result from the following detailed description of the invention based on non-limiting exemplary embodiments with reference to the drawings.

### BRIEF DESCRIPTION OF THE FIGURES

FIG. 1 shows a diagram of the procedure of a first variant of the signature process according to the invention;

FIG. 2 shows a diagram of an examination process according to the invention of an electronic document signed according to the first variant of the signature process;

FIG. 3 shows a diagram of the procedure of a second variant of the signature process according to the invention;

FIG. 4 shows a diagram of an examination process of an electronic document signed according to the second variant of the signature process;

FIG. 5 shows a digital seal edited as a graphic element.

### DETAILED DESCRIPTION

Below, the process according to the invention for an advanced electronic signing of an electronic document is illustrated in several variants.

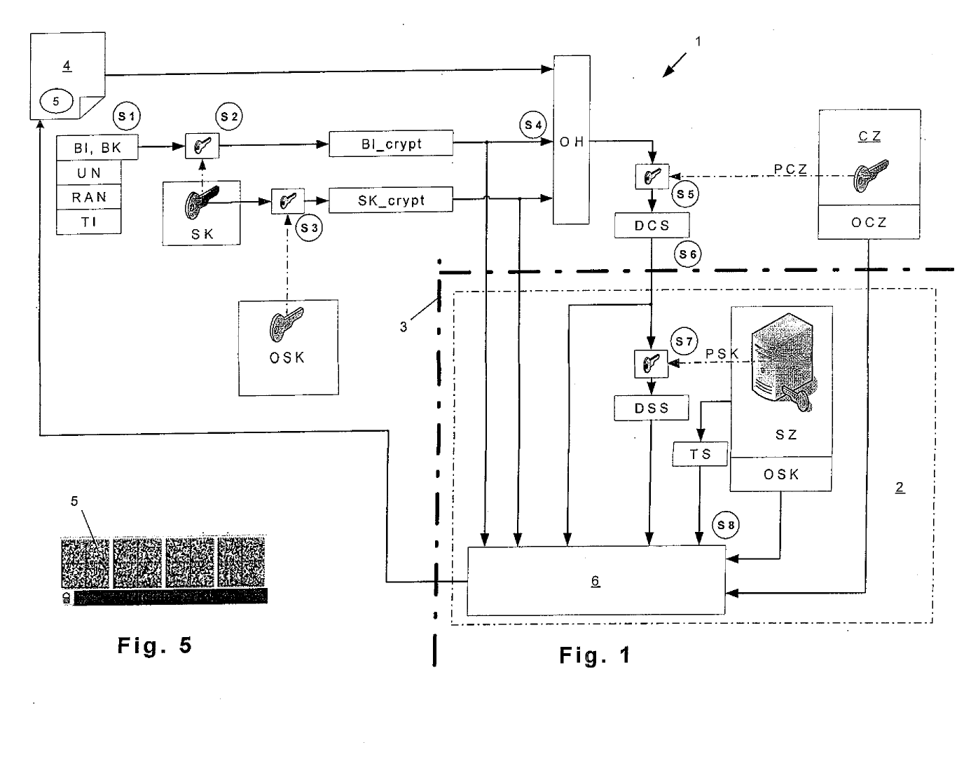

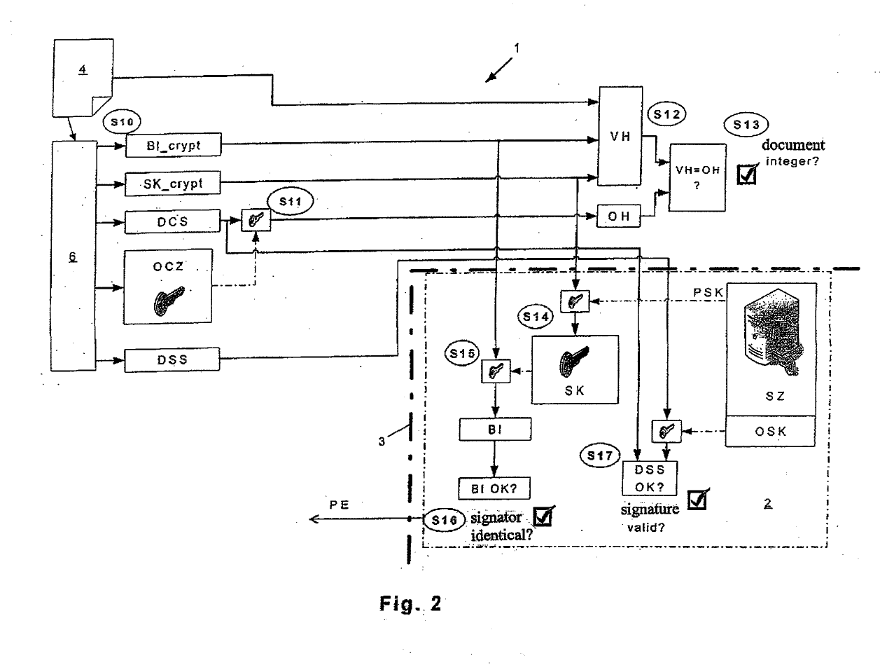

Thereby, a first variant of the signature concept detailed in FIG. 1 comprises a two-stage signature creation based on protected user identification data of the signer, wherein the user identification data is filed in a so-called user account of the signator. The first stage of the signature creation process is performed in a signature creation unit. The second stage of the process is performed in a signature server connected online to the signature creation unit via a data connection such as, e.g., the internet. The examination of electronic documents signed in this way also occurs in two stages as detailed below by way of FIG. 2, with a first stage proceeding in the signature creation unit and the second stage of the examination process proceeding in the signature server.

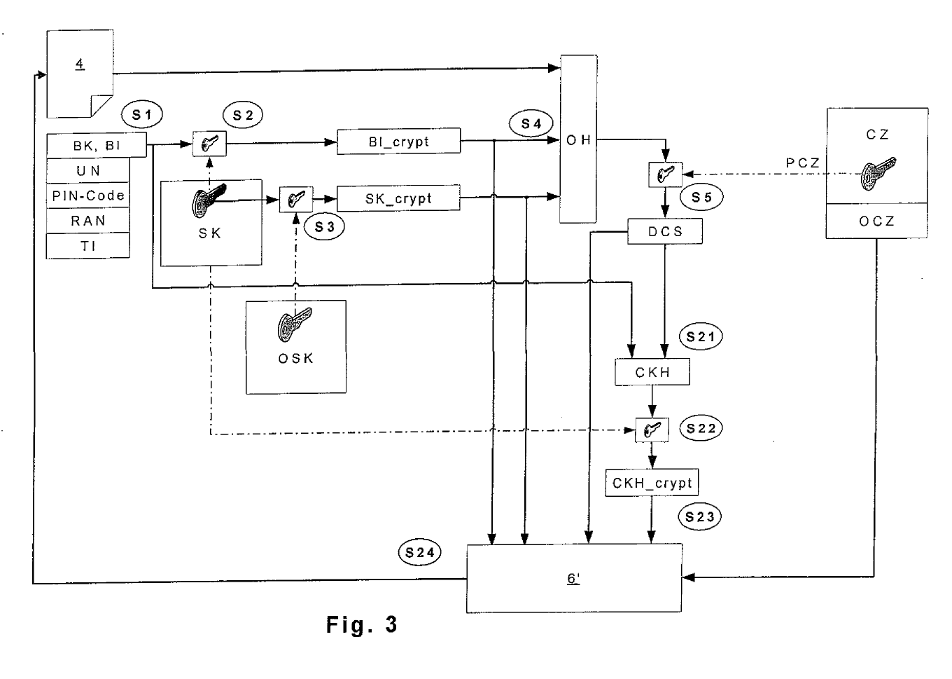

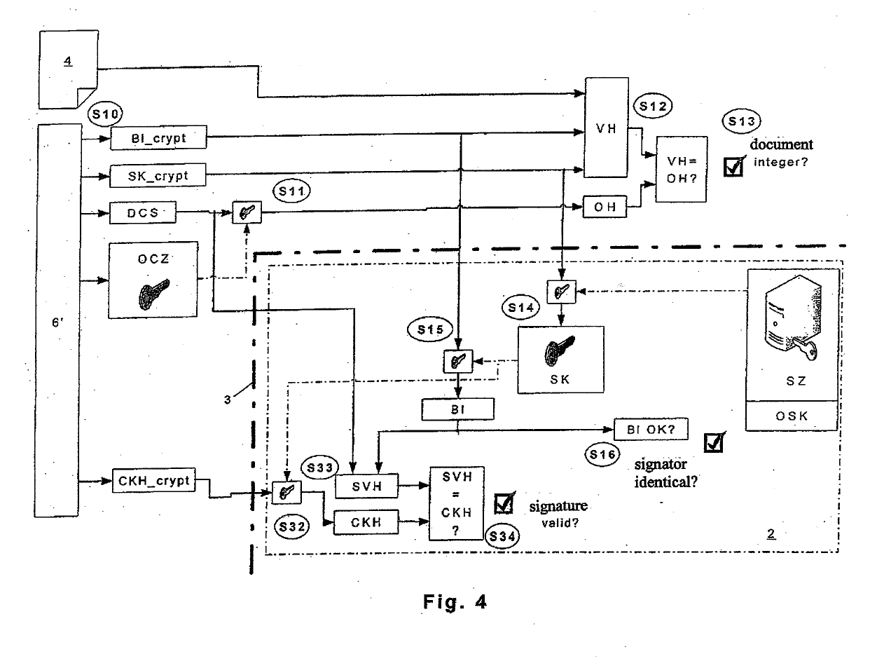

A second variant of the signature concept as illustrated in FIG. 3 comprises a single-stage signature creation in the signature creation unit. Since in said variant of the invention for creating a signature, no data circuit between the signature creation unit and the signature server is required and signature creation occurs exclusively in the signature creation unit. Said variant of the invention is also referred to as an “offline signature creation”. This variant of signature creation is also based on protected user identification data of the signer. However, for a complete examination of electronic documents signed according to the second variant of the invention, a two-stage examination process is again required, as illustrated below by way of FIG. 4, with a first stage proceeding in the signature creation unit and the second stage of the examination process proceeding in the signature server.

However, the basic technical concept of the process according to the invention for an advanced electronic signing of an electronic document using a signature creation unit is very similar in both variants. Therefore, said concept is illustrated at first by way of the first variant, and subsequently the differences between the two variants are explained in detail.

The signature creation unit used in the process according to the invention preferably comprises a computer in which the process according to the invention is executed in the form of a computer program product, which is loaded into a memory of the computer. In doing so, the computer program product can be distributed to users, i.e., signators, for example, while being stored on computer-readable media, however, it can also be offered for download via the internet etc. The signature creation unit operates as a “client”, which is why, in the following description, said term is used as a synonym for the term “signature creation unit”.

In order that the legal requirements of the advanced electronic signature are met, identifiability of the signer is absolutely necessary. For this purpose, the signators have to register with a signature service provider operating a signature server according to the present invention. The identification/authentication of the signators takes place with the registration at the signature service by presenting a valid official photo ID at a registration point of the signature service provider. The presentation of ID can be accomplished by appearing personally at the registration point, or also by FAX.

Due to said identification, the user receives a registration code, which, in principle, allows him or her to use the services of the signature service provider. The registration code is either handed over personally to the user in a closed envelope or is sent, e.g., by e-mail to the address given when registering.

The registration code authorizes the user to deposit an authentication code in the signature server, which authentication code is stored in the signature server under a user account in which further data regarding the user are also filed. The authentication code should have at least six digits so that unauthorized individuals will not be able to easily guess said code by trial and error. In general, it is important that the authentication code be protected from misuse by adequate measures. This also entails that the authentication code on the signature server cannot be viewed or modified, respectively, by any kind of entity. For this reason, the authentication code on the signature server is not stored in plaintext under the user account, but merely the hash value of the authentication code is stored, from which, however, the authentication code can subsequently be calculated and thus the user can be positively identified via his or her authentication code. A “hash value” is understood to be a number or a character string which is calculated from a given character string or an electronic document using a hash algorithm. In simple words, a hash value is comparable to a checksum. Based on the hash value, the original character string or the electronic document, respectively, can be clearly marked and recognized (“electronic fingerprint”).

The authentication code is not stored in the signature creation unit, i.e., on the client's side! Rather, the authentication code is to be safely stored by the signator and is entered each time the signature creation unit is used.

By using the authentication code, the authentication of the user is ultimately ensured by enabling an interaction with the signature server for creating an electronic signature of an electronic document through an online data connection between the signature creation unit and the signature server. In the offline variant, authentication is ensured by effecting a link of the authentication code with the signature.

Using their authentication code, a user can lock his or her user account at any time directly on the signature server. A renewed activation of the user account is then no longer possible.

In case the authentication code is lost, a new authentication code can be issued in a new registration process. Hence, the old authentication code is automatically cancelled and can no longer be used.

According to the invention, in the suggested process, no permanent key pair is allocated alone to a signator.

All signatures are performed either with the keys of the signature server, in particular with the keys of a server certificate issued by a certification station for the signature server, or by means of temporarily generated asymmetric key pairs wherein the private key is destroyed after signing in each case. The respective public key is stored in the signed document, more precisely in a digital seal embedded in the electronic document (explanation follows below).

In addition, symmetric keys are used for encryption of authentication data. These so-called session keys are stored in an asymmetrically encrypted state in the digital seal and hence in the signed electronic document and are destroyed after use. That is, the session keys are not managed originally in any place and thus cannot be spied upon.

Alternatively, it is conceivable that, instead of the temporary key pair, a client signature is performed with the signature creation means (e.g. SmartCard) locally accessible by the user.

If biometric features from signature data are used for the authentication of the signator, the biometric features of the signature are managed in one case on the server side of the signature server, namely, if signator authentication occurs at the moment of registration. In the other case, the raw data of the signature is stored in a symmetrically encrypted state in the electronic document, more precisely in the embedded digital seal, namely, if the signature raw data is stored in the electronic document for later authentication.

Based on FIG. 1, the first variant of the process according to the invention for an advanced electronic signing of an electronic document 4 using a signature creation unit 1 is now explained in detail.

The signing of the document occurs in a two-stage process. First, a protected user account BK of the signator is generated on the client's side, i.e., in the signature creation unit generally indicated by reference numeral 1. The protected user account BK comprises user identification data BI, namely a user name UN, a (real) random number RAN as well as unambiguous temporal information TI about the moment of signature creation. The user identification data BI constitutes unambiguous identification data. See step S1 in FIG. 1.

Next, a symmetric session key SK (e.g. 3DES, . . . etc.) is produced locally, i.e., in the signature creation unit 1. Said session key SK is generated purely randomly in a stochastic process. By means of said session key SK, the user identification data BI is encrypted in process step S2.

Subsequently, the session key SK is asymmetrically encrypted with the public key OSK of a signature server 2, see step S3 in FIG. 1.

The linking of the content of the electronic document 4, of the user identification data BI encrypted with the session key SK (=data stream BI_crypt in FIG. 1) and of the asymmetrically encrypted session key (=data stream SK_crypt) into a common data stream and subsequently the formation of an original hash value OH from said common data stream using a hash algorithm, e.g., the SHA-256 hash algorithm, occur in the following process step S4. Hash algorithms, which, in the literature, are also referred to as hash functions, have the function of generating an output of a (generally) small amount of target data from a usually large amount of source data, in addition to an input, with said amount of target data being referred to as a hash value. A good hash function is characterized in that it produces few collisions for precisely those inputs for which it has been designed. This means that it is possible to differentiate between most inputs with sufficient probability based on their hash values. The algorithms of the SHA (secure hash algorithm) family constitute excellent hash algorithms, wherein the SHA-256 algorithm used for calculating data words having a length of 32 bits is currently preferred for the present application.

Subsequently, in a random process, a “one time” client certificate CZ is now produced locally in the signature creation unit 1, said client certificate possessing an asymmetric key pair OCZ, PCZ. With the aid of the private key PCZ of the client certificate CZ, a digital client signature DCS is now formed on the client 1 by encrypting the original hash value OH with the private key PCZ of the key pair OCZ, PCZ which is available only locally. See step S5 in FIG. 1. After the generation of the digital client signature DCS, the private key PCZ is immediately and effectively destroyed! Thus, the private key PCZ used in this way exists only at the moment of signature creation and, at this point of time, is under the sole control of the signator. It is ensured that said key cannot be reused! Hence, a digital client signature DCS is now provided which comprises both the relevant document content of the electronic document 4 and a link to the personal user identification data BI of the signator.

In the following step S6, the digital client signature DCS and the user identification data BI encrypted with the session key SK (=data stream BI_crypt), the asymmetrically encrypted session key SK (=data stream SK_crypt) and the public key OCZ of the asymmetric one time certificate CZ are sent to the signature server 2 via a secure data connection 3 (e.g., a https connection).

In the signature server 2, the legitimacy of the signator's access to the signature server 2 via the signature creation unit 1 is verified by checking an authentication code which the signator had to enter when starting up the signature creation unit 1. Possibly, said authentication code has already been sent along as a component of the user identification data BI, or the signature server 2 requests said authentication code from the signature creation unit 1. As already mentioned initially, a hash value of the authentication code is stored in the signature server 2 so that a comparison is rendered possible by the formation of a hash value of the authentication code received from the signature creation unit 1.

Upon verification of the signator, the signature server 2 generates a digital server signature DSS by encrypting the digital client signature received from the signature creation unit 1 with the private key PSK of an asymmetric signature-server key pair OSK, PSK of a server certificate SZ. See step S7.

Subsequently, the signature server 2 generates a digital seal 6 in process step S8 by linking the following data into a data file or data stream, respectively:
the user identification data 131 encrypted with the session key SK,
the session key SK encrypted with the public key OSK of the signature server,
the digital client signature DCS,
the digital server signature DSS,
the server certificate SZ with the public key OSZ,
the public key OCZ of the asymmetric one time certificate CZ generated in the signature creation unit, and
a time stamp TS.

The digital seal 6 is sent back to the signature creation unit 1 via the data connection 3 and is embedded there in the electronic document 4. It should be mentioned that, in one variant of the process according to the invention, the electronic document 4 could also be sent to the signature server, which then performs the embedding of the digital seal 6 and returns the document 4 signed in this manner to the signature creation unit 1. However, due to the increased data transmission volume, said variant is not preferred.

On the one hand, the digital seal 6 can be embedded directly in the document content or the file format of the electronic document. On the other hand, however, it can also be edited as a graphic element 5 by coding the information contained in the seal 6 in a graphical form and inserting the graphic element 5 in the electronic document 4 so that it is readable and printable by users and scanners. A currently preferred form of the electronic document is a pdf file. It is also envisaged to convert different file formats into pdf files and to insert the digital seal thus created in the pdf file, wherein, besides an insertion as a graphic element 5, storage in a pdf-signature dictionary and possibly in the pdf metadata is also provided.

FIG. 5 shows an example of a digital seal 6 edited as a graphic element 5.

The advanced signature creation according to the invention also provides protection from “brute force” attacks on the authentication code by preventing an automated repeated testing of the authentication code by progressively incrementing a waiting time in the signature creation unit as well as a maximum possible number of input attempts. After a defined number of incorrect attempts, the user account BK is locked automatically. The corresponding authentication code is cancelled.

The examination of the document 4 signed electronically in this way is now illustrated by way of the diagram of FIG. 2. The examination process is a two-stage process, with the first stage of the examination process being executed offline in the signature creation unit 1 and the second stage being executed in the signature server 2, i.e., an online connection between the signature creation unit 1 and the signature server 2 must be provided.

In the offline stage of the examination process which constitutes an examination of the integrity of the document, the digital seal 6 is extracted from the electronic document 4 in step S10 and its components are isolated. In particular the data stream BI_crypt of the user identification data BI encrypted with the session key SK, the data stream SK_crypt of the session key SK encrypted with the public key OSK of the signature server 2, the digital client signature DCS, the digital server signature DSS, and the public key OCZ of the asymmetric one time certificate CZ generated in the signature creation unit are extracted.

In the following step S11, the digital client signature DCS is decrypted with the public key OCZ of the asymmetric one time certificate CZ which was previously generated in the signature creation unit when signing the document. Hence, the original hash value OH becomes available.

In the following step S12, a comparative hash value VH is now determined from the content of the electronic document 4, the symmetrically encrypted user information data BI, i.e., from the data stream BI_crypt as well as the asymmetrically encrypted session key SK, i.e., from the data stream SK_crypt. In step S13, said comparative hash value VH is compared to the original hash value. If the two hash values are identical, this is evidence for the integrity of the electronic document 4.

The further examination is performed online in the second stage in which the authentication of the signator occurs. For this purpose, the session key SK must be reproduced in the following step S14, which is possible only in the signature server 2. To this end, the signature creation unit 1 sends the session key SK asymmetrically encrypted in the data stream SK_crypt to the signature server 2 via a secure online data connection 3 (e.g., a https connection). Said server decrypts the session key SK with its private key PSK of the server certificate SZ.

Using the now known session key SK, it is possible to decrypt the data stream BI_crypt of the encrypted user information data BI, which data stream has likewise been sent to the signature server 2 by the signature creation unit 1 (step S15), thereby checking the user account BK (step S16).

If the signature creation unit 1 also sends the digital server signature DSS and the digital client signature DCS to the signature server 2, the validity of the digital server signature DSS can likewise be checked in the signature server 2 by decrypting the server signature DSS with the public key OSZ of the server certificate SZ, whereby the original client signature becomes available. Said client signature is compared to the digital client signature DCS transferred by the signature creation unit 1. See step S17. The test result PE of the signator authentication and signature validity examination is returned to the signature creation unit 1 by the signature server 1 and shown to the user.

Based on the diagram of FIG. 3, the second variant of the process according to the invention for generating an advanced electronic signature of an electronic document is now illustrated. Said electronic signature creation occurs in the signature creation unit 1 without access to a signature server, i.e., in an offline manner, but is based, just as in the first variant, on protected user identification data BI and on a protected user account BK, respectively.

In contrast to the first variant of the signature creation process according to the invention, in the present second variant, also the authentication code of the signator is co-stored, e.g. in the form of a PIN code, in the user identification data BI and thus in the user account BK. In said variant, the user identification data BI along with the PIN code are comparable to raw data of a handwritten signature by the signator.

The execution of the electronic signing of the document 4 is identical to process steps S1 to S5 as described above by way of FIG. 1 until the generation of the digital client signature DCS. Therefore, reference is made to the above description.

Although, when creating a signature, various algorithms are unknown to a potential attacker and the respective accesses to the signature server have not been revealed, it is theoretically conceivable that an attacker extracts the appropriate information from an electronic document signed according to the present process. The attacker may then subject a modified electronic document comprising the components extracted from the original signed document to another electronic signature creation in the signature creation unit and on the signature server, being aware of the authentication code and using program parts of the signature creation unit.

In order to prevent also this scenario, in an advanced embodiment of the invention, an additional safety mechanism is implemented which is based on the fact that, in process step S21, a client control hash value CKH is produced from the user identification data BI and the digital client signature DCS. In process step S22, said client control hash value CKH is encrypted into an encoded client control hash value CKH_crypt using the session key SK which is temporarily available only at the moment of signature creation.

Subsequently, the signature creation unit 1 generates a digital seal 6′ in process step S23 by linking the following data into a data file or data stream:
the user identification data BI encrypted with the session key SK (=data stream BK_crypt),
the session key SK encrypted with the public key OSK of a signature server (=data stream SK_crypt),
the digital client signature DCS,
the encrypted client control hash value CKH_crypt, and
the public key OCZ of the asymmetric one time certificate CZ generated in the signature creation unit.

In process step S24, the digital seal 6′ thus created is embedded in the electronic document 4 which thereby receives an advanced electronic signature.

Due to this precautionary measure, an attacker is not able to misuse user information BI stored in the digital seal 6′, since the signature creation process and the encrypted client control hash value CKH_crypt are based on the same session key, which is destroyed after the creation of the signature. Thus, it is ensured that no new signature was created after the destruction of the session key SK and, respectively, that the signature data are clearly linked to the present document.

The examination of the document 4, which has been signed electronically according to the second variant of the signature creation process according to the invention, largely corresponds to the examination process as illustrated above by way of FIG. 2. Particularly the process steps S10 to S15 are identical, which is why reference is made to the above description. Differences to the first examination process are now illustrated by way of the diagram of FIG. 4.

Basically, the second examination process as shown in FIG. 4 is also a two-stage process, with the first stage of the examination process (process steps S10 to S13) being executed offline in the signature creation unit 1 and the second stage being executed in the signature server 2. For this purpose, an online data connection 3 must be provided between the signature creation unit 1 and the signature server 2 so that the signature creation unit 1 is able to send the data streams BI_crypt, SK_Crypt and the digital client signature DCS to the signature server 2. With the aid of the private server key PSK, the session key SK is reconstructed from the data stream SK_crypt (see step S14), and subsequently the user information data BI are decrypted from the data stream BI_crypt by means of the session key SK (step S15). Said data is compared to the information stored in the signature server 2 via the user account BK, whereby identification of the signator is achieved (step S16).

Furthermore, in step S10, the signature creation unit 1 isolates the encrypted client control hash value CKH_crypt from the digital seal 6′ and transfers said encrypted client control hash value CKH_crypt to the signature server 2. In step S32, the signature server 2 decrypts the encrypted client control hash value CKH_crypt by means of the session key SK, whereby the client control hash value CKH is obtained.

Furthermore, in step S33, the signature server 2 calculates a signature server control hash value SVH from the user identification data BI and the digital client signature DCS, using the same algorithm used for the formation of the client control hash value CKH. In step S34, said signature server control hash value SVH is compared to the client control hash value CKH, whereby the validity of the digital signature is determined.

All presented variants of the process according to the invention for generating an advanced electronic signature of an electronic document and of the process according to the invention for examining an electronic document signed electronically in this manner are suitable for the implementation of mass signatures and mass examinations. For this purpose, it must be ensured that the signator signs only those documents which he or she deliberately wishes to sign. This can be accomplished, for example, by a quantitative and temporal limitation of signature operations. In addition, all documents to be signed are suitably placed into a so-called “active signature directory” on the client's side. When a signature process is activated upon entry of the authentication code, all documents from said directory (which have not yet been signed) are conveyed to the signature without the need to enter the authentication code repeatedly.

Furthermore, it should be mentioned that, in an advantageous variant of the signature creation process, an address of the signature server 2, in particular an internet address, is inserted in the electronic document 4, which address is automatically dialled when the examination process is called. In a particularly preferred variant, the address of the signature server 2 is embedded as a link in the electronic document and the user can start the examination process by clicking on said link.

What is claimed is:

1. A process for the generation of an advanced electronic signature of an electronic document (4) using a signature creation unit (1), characterized by:
the generation of unambiguous user identification data (BI) of a signer, wherein at least a subset of the user identification data are stored in a remote signature server (2), also and preferably in an encrypted form;
the generation of a preferably symmetric session key (SK) which is used once when creating a signature;
the encryption (BI_crypt) of the user identification data (BI) with the session key (SK);
the asymmetric encryption (SK_crypt) of the session key (SK) with a public key (OSK) of a signature server (2);
the linking of the content of the electronic document (4), of the user identification data (BI) encrypted (BI_crypt) with the session key and of the asymmetrically encrypted (SK_crypt) session key (SK) into a data stream and the formation of an original hash value (OH) from the data stream using a hash algorithm, e.g., the SHA-256 algorithm;
the generation of an asymmetric one time certificate key pair (PCZ, OCZ);
the generation of a digital client signature (DCS) by encrypting the original hash value (OH) with the private key (PCZ) of the one time certificate key pair,
the generation of a digital seal (6, 6′) by compiling the following data:
the user identification data (BI) encrypted (BI_crypt) with the session key,
the session key (SK) encrypted (SK_crypt) with the public key of a signature server,
the digital client signature (DCS), and
the public key (OCZ) of the asymmetric one time certificate key pair,
wherein the generation of the digital seal (6, 6′) is effected in the signature creation unit (1) or in a signature server (2) connectable to the signature creation unit via a data connection (3);
the embedding of the digital seal (6, 6′) in the electronic document (4).

2. A process according to claim 1, characterized in that the digital seal (6, 6′) is edited as a graphic element (5), into which the data of the digital seal are coded in a machine-readable form, and the graphic element (5) is inserted in the electronic document (4).

3. A process according to claim 1, characterized in that an address of the signature server, in particular an internet address, is inserted in the electronic document (4).

4. A process according to claim 1, characterized in that the user identification data (BI) comprise a user identification character (UN) or a user account identification character, respectively, and/or a random number (RAN) and/or biometric data, e.g., biometric features from signature data and/or a time stamp (TI) of the moment of signature creation.

5. A process according to claim 1, characterized in that the user identification data (BI) comprise an authentication code (PIN code) of the signator.

6. A process according to claim 1, characterized in that, when the digital seal (6) is generated in the signature server (2), a digital server signature (DSS) as well as, optionally, a time stamp (TS) are inserted in the digital seal.

7. A process according to claim 6, characterized in that the digital server signature (DSS) is generated by encrypting the digital client signature (DCS) with the private key (PSK) of an asymmetric signature server key pair (PSK, OSK), preferably of a certificate key pair.

8. A process according to claim 6, characterized in that a certificate (SZ) issued for the signature server as well as, optionally, a public key (OSZ) of a certificate key pair of the certificate (SZ) are inserted in the digital seal (6).

9. A process according to claim 1, characterized in that, when the digital seal (6′) is generated in the signature creation unit (1), a client control hash value CKH is produced from the user identification data (BI) and the digital client signature (DCS) and is inserted in the digital seal.

10. A process according to claim 9, characterized in that the client control hash value (CKH) is encrypted (CKH_crypt) with the session key (SK) before being inserted in the digital seal (6′).

11. A process for the examination of an electronic document (4) signed electronically according to the process of claim 1, using a signature creation unit (1), characterized by
extracting the digital seal (6, 6′) from the electronic document (4) and isolating the following data from the digital seal:
the user identification data (BI) encrypted (BI_crypt) with the session key (SK),
the session key (SK) encrypted (SK_crypt) with the public key (OSK) of a signature server (2),
the digital client signature (DCS), and
the public key (OCZ) of the asymmetric one time certificate key pair (OCZ, PCZ);
decrypting the digital client signature (DCS) with the public key (OCZ) of the one time certificate key pair, whereby the original hash value (OH) coded in the digital client signature becomes available;
forming a comparative hash value (VH) by linking the content of the electronic document (4), of the user identification data (BI) encrypted (BI_crypt) with the session key and of the asymmetrically encrypted (SK_crypt) session key (SK) into a data stream and calculating the comparative hash value (VH) from the data stream using the hash algorithm used for the formation of the original hash value (OH);
comparing the original hash value (OH) with the comparative hash value (VH), whereby, in case of a match, the integrity of the electronic document (4) is provided.

12. A process according to claim 11, characterized by transferring the user identification data encrypted (BI_crypt) with the session key and the session key encrypted (SK_crypt) with the public key of the signature server to the signature server (2), whereupon, via the signature server (2), the session key (SK) is decrypted with the private key (PSK) of the signature server and, using the now available session key, the user identification data (BI) are decrypted and the identity of the signer is checked from the user identification data (BI).

13. A process according to claim 11, characterized by isolating the digital server signature (DSS) from the digital seal (6), transferring the digital server signature (DSS) to the signature server (2) and comparing the digital server signature (DSS) or the data contained therein, respectively, in the signature server with a server signature stored in the signature server or with the data contained therein, respectively.

14. A process according to claim 13, characterized in that, in the signature server (2), the digital server signature (DSS) received is decrypted with the associated public key (OSK) and the digital client signature thus available is compared with respect to a match with the digital client signature (DCS) isolated from the digital seal.

15. A process according to claim 12, characterized by isolating the client control hash value (CKH, CKH_crypt) from the digital seal (6′), transferring the client control hash value (CKH, CKH_crypt) to the signature server (2), calculating, on the signature server side, a signature server control hash value (SVH) from the user identification data (BI) and the digital client signature (DCS) by means of the hash algorithm used for the formation of the client control hash value (CKH) and comparing the client control hash value (CKH) with the signature server control hash value (SVH).

16. A process according to claim 15, characterized in that the encrypted client control hash value (CKH_crypt) is decrypted in the signature server (2) with the reproduced session key (SK).

17. A computer program product which is loadable into a memory of a computer, characterized by software code portions for implementing the steps of the process according to claim 1 wherein the computer program product is processed in the computer.

18. A computer program product according to claim 17, wherein the computer program product is stored on a computer-readable medium.

19. A signature creation unit (1) comprising an arithmetic unit and an internal memory, which signature creation unit processes the computer program product according to claim 17.
